(19) United States
(12) Patent Application Publication
(10) Pub. No.: US 2026/0088685 A1
(43) Pub. Date: Mar. 26, 2026

(54) DISTRIBUTED DC LINK

(71) Applicant: H3X TECHNOLOGIES INC., Louisville, CO (US)

(72) Inventors: Max Meyer Liben, Louisville, CO (US); Jason Jerome Sylvestre, Louisville, CO (US)

(21) Appl. No.: 19/110,176

(22) PCT Filed: Sep. 11, 2023
(86) PCT No.: PCT/US2023/073832

§ 371 Date: Mar. 10, 2025

Related U.S. Application Data
(60) Provisional application No. 63/405,575, filed on Sep. 12, 2022.

(51) Int. Cl. H02K 11/33; H02M 7/00

(52) U.S. Cl. CPC H02K 11/33; H02M 7/003; H02K 2203/09

(57) ABSTRACT

An integrated motor drive includes a housing with a cooling channel positioned therein. The integrated motor drive includes a stator positioned within the housing and a distributed DC link assembly positioned 360 degrees around the housing. The distributed DC link assembly includes a plurality of capacitor assemblies and a plurality of power modules, and the plurality of capacitors assemblies and the plurality of power modules are coupled the housing and configured to be cooled by the cooling channel.

### CROSS-REFERENCE TO RELATED APPLICATIONS

This application claims priority to and the benefit of U.S. Provisional Patent Application No. 63/405,575 , filed Sep. 12, 2022, and is incorporated herein by reference in its entirety for all purposes.

### TECHNICAL FIELD

The present disclosure relates to a distributed DC link for use in, for example, an integrated motor drive.

### BACKGROUND

Conventional DC links include busbars and capacitors and act as an energy buffer between a DC energy storage (e.g., a battery, fuel cell, etc.) and a power conversion stage (e.g., a semiconductor power stage).

### SUMMARY

The disclosure provides, in one aspect, a distributed DC link assembly including a first busbar assembly positioned around an axis and a second busbar assembly positioned around the axis. The first busbar assembly extends 360 degrees around the axis and the second busbar assembly extends 360 degrees around the axis.

In some embodiments, the assembly further includes a plurality of capacitor assemblies coupled to the first busbar assembly and the second busbar assembly.

In some embodiments, the assembly further includes a plurality of electromagnetic interference filter electrically coupled to the first busbar assembly, the second busbar assembly, and a ground.

In some embodiments, the first busbar assembly is at first voltage and the second busbar assembly is at a second voltage lower than the first voltage.

The disclosure provides, in another aspect, a distributed DC link assembly including a first busbar sector, a second busbar sector electrically coupled to the first busbar sector, and a third busbar sector electrically coupled to the first busbar sector and the second busbar sector. A first end of the third busbar sector is mechanically coupled to the first busbar sector and a second end of the third busbar sector is mechanically coupled to the second busbar sector. The first busbar sector, the second busbar sector, and the third busbar sector are positioned an equal distance from a central axis.

In some embodiments, the second busbar sector is identical to the first busbar sector.

In some embodiments, the third busbar sector is identical to the first busbar sector.

In some embodiments, the first busbar sector, the second busbar sector, and the third busbar sector form a closed loop around the central axis.

The disclosure provides, in another aspect, an integrated motor drive including a housing with a cooling channel positioned therein, a stator positioned within the housing, and a distributed DC link assembly positioned 360 degrees around the housing. The distributed DC link assembly includes a plurality of capacitor assemblies and a plurality of power modules. The plurality of capacitor assemblies and the plurality of power modules are coupled the housing and configured to be cooled by the cooling channel.

In some embodiments, the integrated motor drive further includes a thermal layer positioned between each of the plurality of capacitor assemblies and the housing and positioned between each of the plurality of power modules and the housing.

In some embodiments, the distributed DC link assembly includes an electromagnetic interference filter with a Y-capacitor, and a ground bridge coupling the electromagnetic interference filter to a ground.

In some embodiments, the integrated motor drive further includes a circuit board positioned radially outward from the distributed DC link assembly, and a ground plate positioned between the circuit board and the distributed DC link assembly. The circuit board interfaces with the ground plate through an EMI gasket.

In some embodiments, the ground plate is electrically coupled to a ground.

The disclosure provides, in another aspect, a busbar assembly including a first busbar with a first portion and a second portion extending from the first portion at an angle, and a second bus bar with a third portion and a fourth portion extending from the third portion at the angle. The busbar assembly further includes a capacitor assembly electrically coupled to the first busbar and the second busbar. The capacitor assembly is mounted to the first portion of the first busbar and the third portion of the second busbar. The busbar assembly further includes an electromagnetic interference filter with a capacitor electrically coupled to the first busbar, the second bus bar, and a ground. The electromagnetic interference filter is mounted to the second portion of the first busbar and the fourth portion of the second busbar.

In some embodiments, the first portion is parallel to the third portion and the second portion is parallel to the fourth portion.

In some embodiments, the first busbar includes a first interconnect portion extending from the first portion at the angle.

In some embodiments, the first busbar includes a second interconnect portion extending from the second portion at the angle.

In some embodiments, the second busbar includes a third interconnect portion extending from the third portion at the angle; and the second busbar includes a fourth interconnect portion extending from the fourth portion at the angle.

In some embodiments, the third interconnect portion is parallel to the first interconnect portion, and wherein the fourth interconnect portion is parallel to the second interconnect portion.

In some embodiments, the first interconnect portion includes a first plurality of slots and the second interconnect portion includes a first plurality of connectors. The third interconnect portion includes a second plurality of slots and the fourth interconnect portion includes a second plurality of connectors.

In some embodiments, the first plurality of slots includes insulated slots and exposed slots positioned alternatingly along an interconnect axis; and wherein the second plurality of slots includes insulated slots and exposed slots; and wherein the insulated slots of the second plurality of slots are aligned with the exposed slots of the first plurality of slots; and wherein the exposed slots of the second plurality of slots are aligned with the insulated slots of the first plurality of slots.

In some embodiments, the first plurality of connectors and second plurality of connectors are positioned alternatingly along an interconnect axis.

In some embodiments, the angle is 60 degrees.

In some embodiments, the busbar assembly further includes a power module with two switching elements. The power module is electrically coupled to the first busbar and the second busbar, wherein the power module is mounted to the second portion of the first busbar and the fourth portion of the second busbar.

In some embodiments, the capacitor of the electromagnetic interference filter is a Y capacitor coupled to a circuit board. The electromagnetic interference filter further includes a ground bridge that extends between a power module and the circuit board.

In some embodiments, first busbar includes an aperture formed in the second portion, and wherein an electrical connection to the power module extends through the aperture.

In some embodiments, the first busbar and the second busbar extend through the capacitor assembly such that the capacitor assembly is at least partially positioned radially inward and radially outward of the first busbar and the second busbar.

In some embodiments, the capacitor assembly includes an equivalent series resistance of less than 1 mΩ.

In some embodiments, the capacitor assembly, the first busbar, and the second bus bar have a total equivalent series inductance of less than 10 nH.

In some embodiments, the first busbar includes a first terminal extending from the first portion, and the second busbar includes a second terminal extending from the third portion; wherein the first terminal is spaced from and parallel to the second terminal.

In some embodiments, the first portion and the second portion are planar.

In some embodiments, the first busbar includes an aluminum core and an electrically insulating coating.

Other aspects of the disclosure will become apparent by consideration of the detailed description and accompanying drawings.

### BRIEF DESCRIPTION OF THE DRAWINGS

These and other features, aspects, and advantages of the present technology will become better understood with regards to the following drawings. The accompanying figures and examples are provided by way of illustration and not by way of limitation.

FIG. 1 is a perspective view of a distributed DC link assembly include three busbar sectors.

FIG. 2 is an end view of the distributed DC link assembly of FIG. 1.

FIG. 3 is a partial cross-sectional view of the distributed DC link assembly at a connection between two busbar sectors.

FIG. 4 is a perspective view of a busbar sector of the distributed DC link assembly of FIG. 1, illustrating two busbars.

FIG. 5 is another perspective view of the busbar sector of FIG. 4.

FIG. 6 is an end view of the busbar sector of FIG. 4.

FIG. 7 is a cross-sectional view of the busbar sector of FIG. 4.

FIG. 8 is a partial cross-section view of an integrated motor drive including the distributed DC link assembly of FIG. 1, illustrating a common mode path.

Before any embodiments are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,”“can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

As used herein, “DC link” refers to an energy buffer between a DC energy storage (e.g., a battery, fuel cell, etc.) and a power conversion stage (e.g., a semiconductor power stage).

The term “coupled,” as used herein, is defined as “connected,” although not necessarily directly, and not necessarily mechanically. The term coupled is to be understood to mean physically, magnetically, chemically, fluidly, electrically, or otherwise coupled, connected or linked and does not exclude the presence of intermediate elements between the coupled elements absent specific contrary language.

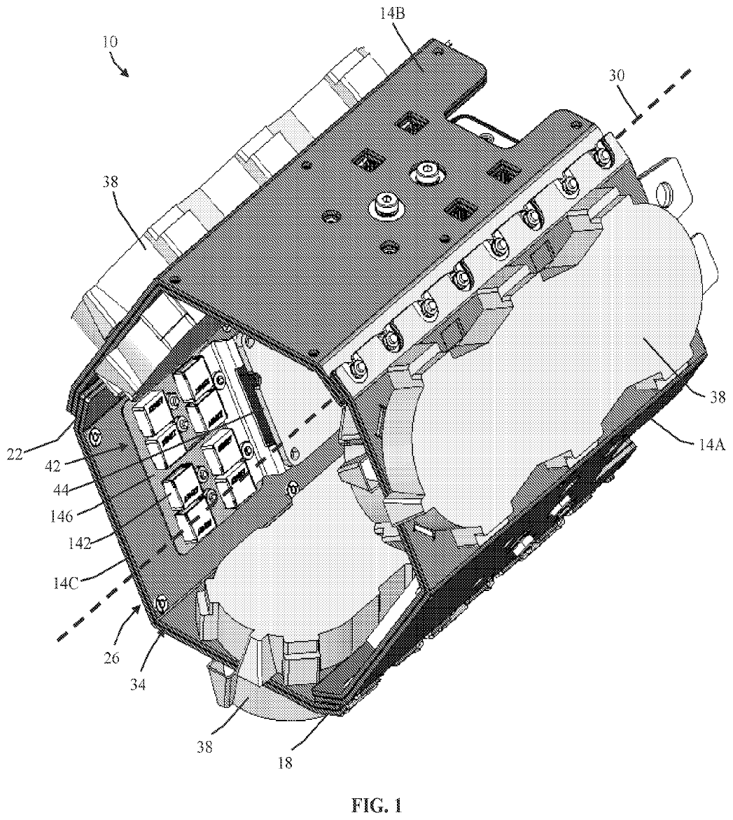

With reference to FIG. 1, a distributed DC link assembly 10 includes a plurality of busbar sectors 14. As used herein, the term “busbar assembly” is also used to refer to one of the plurality of busbar sectors 14. In the illustrated embodiment, the plurality of busbar sectors 14 includes a first busbar sector 14A, a second busbar sector 14B, and a third busbar sector 14C. In other embodiments, the plurality of busbar sectors 14 includes more than three busbar sectors. In the illustrated embodiment, the second busbar sector 14B is electrically coupled to the first busbar sector 14A, and the third busbar sector 14C is electrically coupled to the first busbar sector 14A and the second busbar sector 14B. In other words, the busbar sectors 14A-14C are electrically coupled together. In addition, a first end 18 of the third busbar sector 14C is mechanically coupled to the first busbar sector 14A and a second end 22 of the third busbar sector 14C is mechanically coupled to the second busbar sector 14B.

Together the busbar sectors 14A-C form a first busbar assembly 26 (e.g., a positive high voltage busbar, HV+) positioned around a central, longitudinal axis 30, and a second busbar assembly 34 (e.g., a negative high voltage busbar, HV−) positioned around the axis 30. In other words, the first busbar assembly 26 is at first voltage and the second busbar assembly 34 is at a second voltage lower than the first voltage.

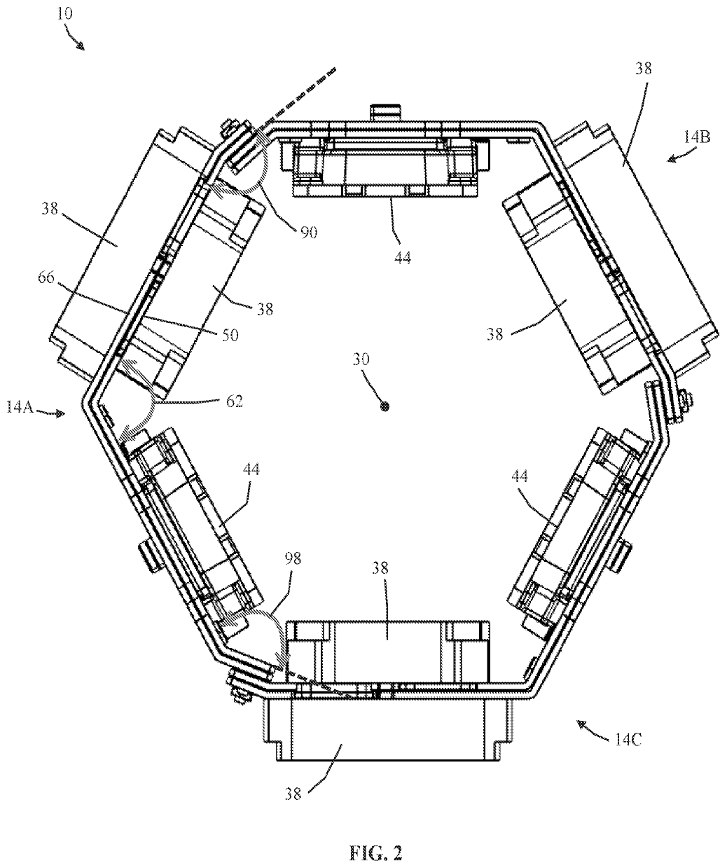

In the illustrated embodiment, the first busbar assembly 26 extends 360 degrees around the axis 30 and the second busbar assembly 34 extends 360 degrees around the axis 30. In other words, the busbar assemblies 26, 34 extend entirely around the center longitudinal axis 30 of the electric motor drive. In the illustrated embodiment, the second busbar assembly 34 is co-axial with the first busbar assembly 26. In the illustrated embodiment, the first busbar sector 14A, the second busbar sector 14B, and the third busbar sector 14C are each positioned an equal distance radially from the central axis 30. The first busbar sector 14A, the second busbar sector 14B, and the third busbar sector 14C form a closed loop (FIG. 2) around the central axis 30. As detailed here, when the busbar sectors 14 are assembled together to form a closed loop, the resistance and inductance of the distributed DC link assembly 10 is advantageously reduced. The resistance and inductance are reduced because the closed loop provides an additional path for current to flow. In other words, at any point on busbar assemblies 26, 34, there are two parallel paths (e.g., clockwise and counterclockwise as viewed from FIG. 2) for current to flow, reducing the resistance and inductance by half.

With continued reference to FIG. 1, the distributed DC link assembly 10 includes a plurality of capacitor assemblies 38 mechanically and electrically coupled to the first busbar assembly 26 and the second busbar assembly 34. In some embodiments, each of the capacitor assemblies 38 is a ceramic capacitor that is surface mount soldered. In some embodiments, each of the capacitor assemblies 38 is a film capacitor.

With continued reference to FIG. 1, the distributed DC link assembly 10 includes a plurality of electromagnetic interference (EMI) filters 42 mechanically coupled to the first busbar assembly 26 and the second busbar assembly 34. In the illustrated embodiment, the plurality of EMI filters 42 are electrically coupled to the first busbar assembly 26, the second busbar assembly 34, and a chassis ground (e.g., an inner housing 46, FIG. 8). The distributed DC link assembly 10 further includes a plurality of power modules 44 mechanical and electrically coupled to the first busbar assembly 26 and the second busbar assembly 34.

In the illustrated embodiment, the second busbar sector 14B is identical to the first busbar sector 14A, and the third busbar sector 14C is identical to the first busbar sector 14A. In some embodiments, all the busbar sectors 14 are identical. Identical busbar sectors 14 advantageously reduce manufacturing cost by using economies of scale. As such, details provided herein regarding one DC link busbar sector are relevant and apply equally to other DC link busbar sectors.

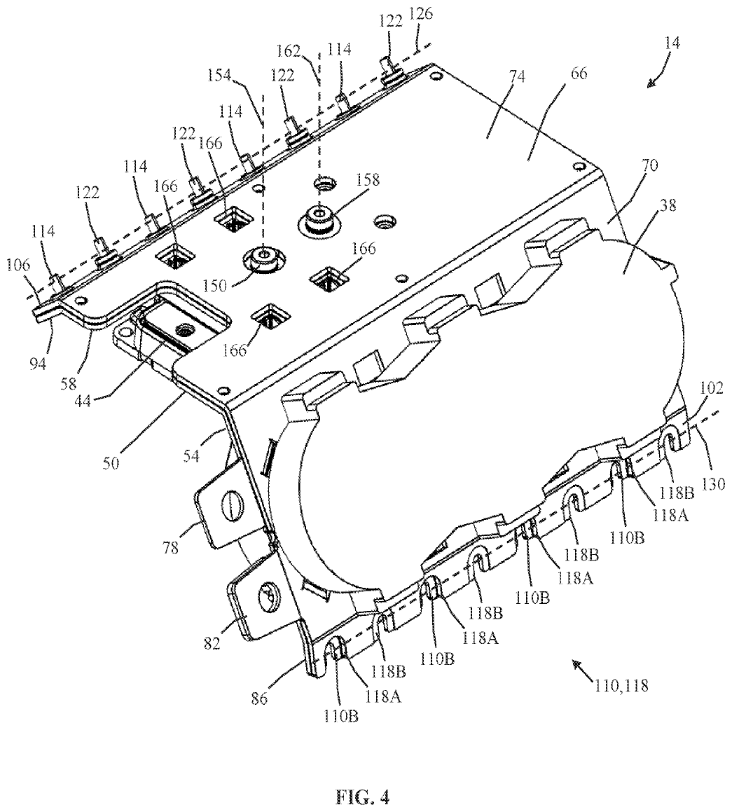

With reference to FIGS. 4-6, the first busbar sector 14A is illustrated. Details of the first busbar sector 14A are provided herein, and those details also apply to the second busbar sector 14B and the third busbar sector 14C, which in the illustrated embodiment, are identical to the first busbar sector 14A. As such, the following description will refer to the first busbar sector 14A as a busbar assembly 14 more generally.

The busbar assembly 14 includes a first busbar 50 with a first portion 54 and a second portion 58 extending from the first portion 54 at an angle 62. In the illustrated embodiment, the first portion 54 is planar and the second portion 58 is planar. The busbar assembly 14 also includes a second busbar 66 with a third portion 70 and a fourth portion 74 extending from the third portion 70 at the angle 62. In the illustrated embodiment, the first portion 54 is parallel to the third portion 70, and the second portion 58 is parallel to the fourth portion 74. The first busbar 50 is positioned radially inward from the second busbar 66. In some embodiments, the first busbar 50 and the second busbar 66 include an aluminum core and an electrically insulating coating.

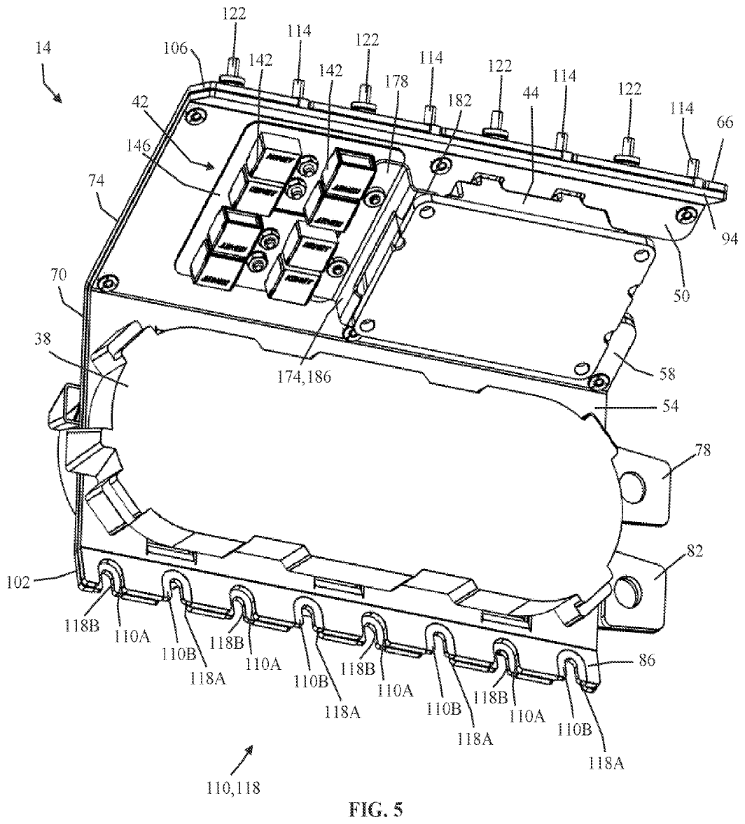

With reference to FIGS. 4 and 5, the first busbar 50 includes a first terminal 78 extending from the first portion 54, and the second busbar 66 includes a second terminal 82 extending from the third portion 70. In the illustrated embodiment, the first terminal 78 is spaced from and parallel to the second terminal 82. In some embodiments, the first terminal 78 is co-planar with the first portion 54 and the second terminal 82 is co-planar with the third portion 70. The first terminal 78 and the second terminal 82 serve as high voltage input connection points (e.g., HV+, HV− from, for example, a battery pack assembly).

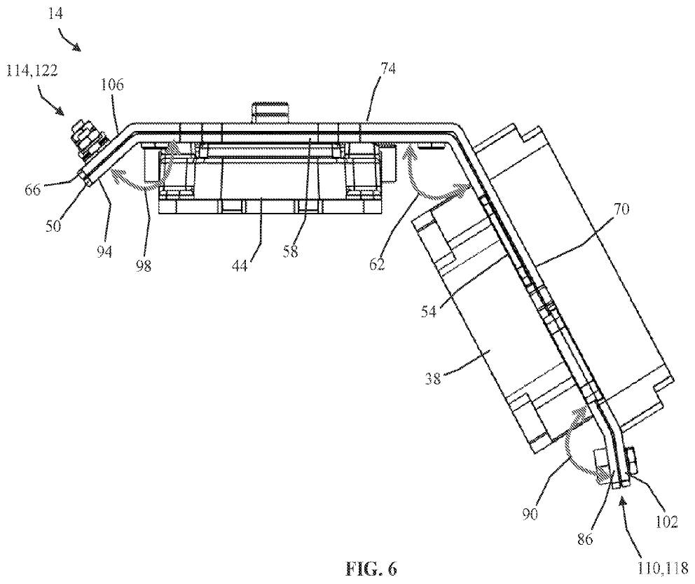

With reference to FIG. 6, the first busbar 50 includes a first interconnect portion 86 extending from the first portion 54 at an angle 90. The first busbar 50 includes a second interconnect portion 94 extending from the second portion 58 at an angle 98. In the illustrated embodiment, the angle 62, the angle 90, and the angle 98 are equal. In the illustrated embodiments, the angles 62, 90, 98 are each approximately 60 degrees.

With continued reference to FIG. 6, the second busbar 66 includes a third interconnect portion 102 extending from the third portion 70 at the angle 90. The second busbar 66 includes a fourth interconnect portion 106 extending from the fourth portion 74 at the angle 98. In the illustrated embodiment, the third interconnect portion 102 is parallel to the first interconnect portion 86, and the fourth interconnect portion 106 is parallel to the second interconnect portion 94.

With reference to FIGS. 4 and 5, on the first busbar 50, the first interconnect portion 86 includes a first plurality of slots 110 and the second interconnect portion 94 includes a first plurality of connectors 114. On the second busbar 66, the third interconnect portion 102 includes a second plurality of slots 118 and the fourth interconnect portion 106 includes a second plurality of connectors 122. In other words, the connectors 114, 122 on the busbars 50, 66 are at the same end of the busbars 50, 66. The first plurality of connectors 114 and the second plurality of connectors 122 are positioned alternatingly along an interconnect axis 126. In other words, a connector on the second busbar is positioned between two connectors on the first busbar.

Similarly, the slots 110, 118 on the busbars 50, 66 are at the same end of the busbars 50, 66. The first plurality of slots 110 includes insulated slots 110A and exposed slots 110B positioned alternatingly along an interconnect axis 130. In other words, the first plurality of slots 110 includes insulated slots 110A and exposed slots 110B arranged in an alternating pattern. In some embodiments, the insulated slots 110A are larger than the exposed slots 110B. In other words, the insulated slots 110A provide clearance for a corresponding connector (e.g., one of the connectors 114, 122) of an adjacent busbar sector to pass through.

Similarly, the second plurality of slots 118 includes insulated slots 118A and exposed slots 118B. In the illustrated embodiment, the insulated slots 118A of the second plurality of slots 118 are aligned with the exposed slots 110B of the first plurality of slots 110, and the exposed slots 118B of the second plurality of slots 118 are aligned with the insulated slots 110A of the first plurality of slots 110. In other words, at each position along the interconnect axis 130 there are two aligned slots (one exposed slot and one insulated slot), with one of the slots formed on the first busbar 50 and the other slot formed on the second busbar 66.

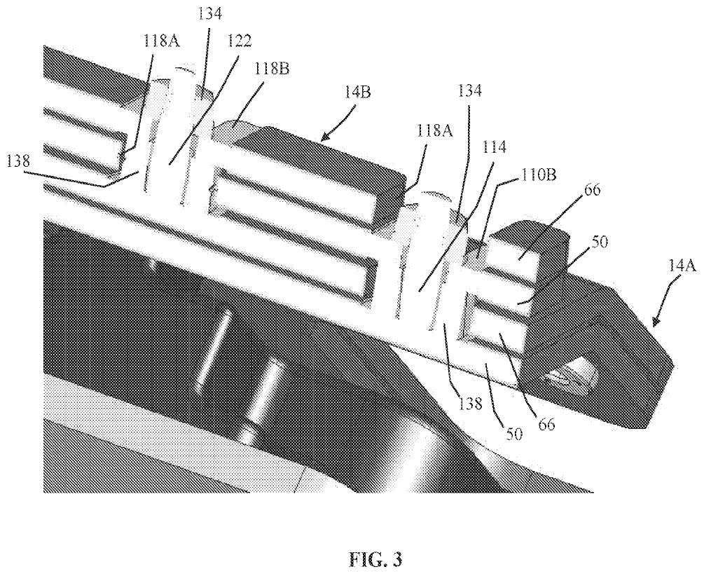

With reference to FIG. 3, connectors 114, 122 on the first busbar sector 14A are received and secured within slots 110, 118 on the second busbar sector 14B. In some embodiments, a nut 134 secures the connector to the corresponding slot. In some embodiments, cylindrical spacers 138 are provided between the connectors and slots. In the illustrated embodiment, the cylindrical spacers 138 are conductive and electrically connect the busbar of one sector to the busbar of another sector. The cylindrical spacers 138 are better electrical conductors than bolts alone.

With continued reference to FIGS. 4-6, the busbar assembly 14 includes a capacitor assembly 38 (i.e., one of the plurality of capacitor assemblies 38) electrically coupled to the first busbar 50 and the second busbar 66. The capacitor assembly 38 is mechanically coupled (e.g., mounted) to the first portion 54 of the first busbar 50 and the third portion 70 of the second busbar 66. In the illustrated embodiment, the first busbar 50 and the second busbar 66 extend through the capacitor assembly 38 such that the capacitor assembly 38 is at least partially positioned radially inward and radially outward of the busbars 50, 66. In other words, the busbars 50, 66 in the illustrated embodiment extend through a middle portion of the capacitor assembly 38. In other embodiments, the capacitor assembly 38 is positioned entirely on a radially inward surface of the first busbar 50.

The plurality of capacitor assemblies 38 ultimately drives the volume and physical size of a DC link, and the DC link may make up a significant portion of the total inverter volume. As such, it is undesirable to have more capacitance than you need because it results in an over-sized system. The plurality of capacitor assemblies 38 disclosed herein are designed to achieve a pre-determined bus voltage ripple (e.g., plus or minus 5 percent, plus or minus 40 V for a 800 V bus, etc.) that is inversely proportional to switching frequency. In some embodiments, where the switching frequency is 50 kHz, the amount of capacitance required is reduced compared to conventional drives that operate in the 5-15 kHz range. In the illustrated embodiment, the plurality of capacitor assemblies 38 are sized to ensure the voltage ripple is below a threshold, but no larger. In some embodiments, the capacitor assembly 38 includes an equivalent series resistance (ESR) of less than approximately 1 mΩ. In some embodiments, the ESR of the capacitor assembly 38 is less than approximately 100 μΩ.

With continued reference to FIGS. 4-6, the busbar assembly 14 includes an electromagnetic interference (EMI) filter 42 (e.g., one of the plurality of EMI filters 42) electrically coupled to the first busbar 50, the second busbar 66, and a chassis ground (e.g., the inner housing 46). In the illustrated embodiment, the EMI filter 42 is mechanically coupled (e.g., mounted) to the second portion 58 of the first busbar 50 and the fourth portion 74 of the second busbar 66. In some embodiments, the EMI filter 42 includes one or more Y-capacitors 142 coupled to a circuit board 146. The Y-capacitors 142 are electrically connected between the DC bus and chassis ground to provide a preferable current path back to the DC bus and in doing so reduce or eliminate common mode EMI. As detailed herein, the Y-capacitors 142 provides a low-impedance path for common mode current in chassis ground to flow back to the DC bus.

With continued reference to FIGS. 4-6, the busbar assembly 14 includes a power module 44 (e.g., one of the plurality of power modules 44) with at least one switching element (e.g., a SiC semiconductor). In the illustrated embodiment, each of the power modules 44 include two switching elements. In some embodiments, the switching frequency for the switching element is approximately 50 kHz. In the illustrated embodiment, the power module 44 is mounted to the second portion 58 of the first busbar 50 and the fourth portion 74 of the second busbar 66. The power module 44 is electrically coupled to the first busbar 50 with a first connector 150 extending along a first axis 154, and the second busbar 66 with a second connector 158 extending along a second axis 162. In the illustrated embodiment, the first axis 154 is spaced apart and approximately parallel to the second axis 162.

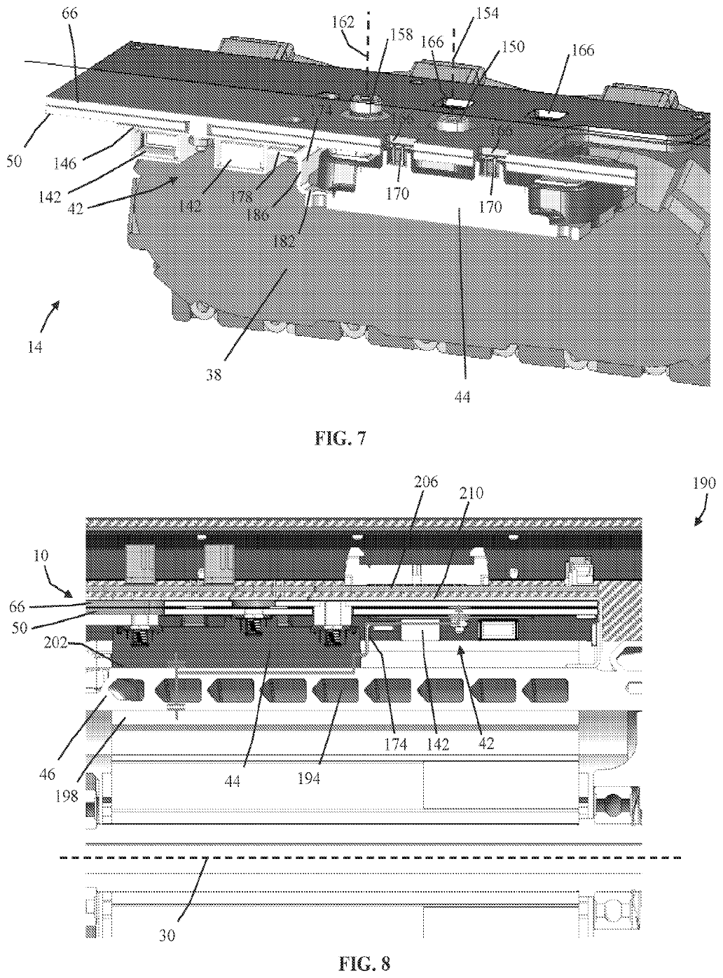

With reference to FIGS. 4 and 7, the first busbar 50 and the second busbar 66 include apertures 166 formed in the second portion 58 and fourth portion 74, respectively. In the illustrated embodiments, the apertures 166 are insulated square-shaped openings. An electrical connection 170 (e.g., a header connection) to the power module 44 extends through the apertures 166 (FIG. 7). In some embodiments, the electrical connection 170 to the power module 44 is for gate drive, module temperature sensing, etc.

In the illustrated embodiment, the busbar assembly 14 further includes a ground bridge 174 that extends between the power module 44 and the circuit board 146 of the EMI filter 42. With reference to FIG. 7, the ground bridge 174 includes a first mount portion 178 coupled to the circuit board 146, a second mount portion 182 coupled to the power module 44, and an intermediate portion 186 extending between the first mount portion 178 and the second mount portion 182. In some embodiments, the first mount portion 178 is approximately parallel to the second mount portion 182. In the illustrated embodiment, the ground bridge 174 electrically couples the EMI filter 42 to chassis ground. In some embodiments, the ground bridge 174 extends from the circuit board 146 directly to the inner housing 46.

In some embodiments, the capacitor assembly 38, the first busbar 50, and the second busbar 66 have a total equivalent series inductance (ESL) of less than approximately 10 nH. In some embodiments, the capacitor assembly 38, the first busbar 66, and the second busbar 66 have a total ESL of less than approximately 5 nH.

With reference to FIG. 8, the distributed DC link assembly 10 is part of an integrated motor drive 190. In some embodiments, the integrated motor drive 190 includes the inner housing 46 with a cooling channel 194 positioned therein (e.g., a cooling jacket). Such a housing is detailed in PCT Patent Application No. PCT/US21/57691, filed Nov. 2, 2021, incorporated herein by reference in its entirety. A stator 198 is positioned within the inner housing 46 and cooled by the cooling channel 194. The distributed DC link assembly 10 detailed herein is positioned 360 degrees around the inner housing 46. In other words, the inner housing 46 is positioned within (e.g., surrounded by) the distributed DC link assembly 10. As described herein, the distributed DC link assembly 10 includes the plurality of capacitor assemblies 38 and the plurality of power modules 44. In the illustrated embodiment, the plurality of capacitors assemblies 38 and the plurality of power modules 44 are coupled to the inner housing 46 and configured to be cooled by the cooling channel 194. As such, the cooling channel 194 cools both the stator 198 (motor) and the distributed DC link assembly 10.

With reference to FIG. 8, the integrated motor drive 190 includes a thermal layer 202 positioned between the power modules 44 and the inner housing 46. The integrated motor drive 190 also includes a thermal layer positioned between each of the capacitor assemblies 38 and the inner housing 46. In some embodiments, the thermal layer is a thin layer of thermal paste to improve contact resistance. In some embodiments, the thermal layer is a thermal pad. In other words, thermal layers are positioned between each of the plurality of capacitor assemblies 38 and the inner housing 46, and positioned between each of the plurality of power modules 44 and the housing 46. In other embodiments, the capacitor assemblies 38 and power modules 44 are in direct contact with the inner housing 46 (e.g., with no thermal layer).

Advantageously, the integrated motor drive 190 detailed herein provides enhanced cooling. Ripple current capability for a motor drive is inversely proportional to \sqrt{ESR} and \sqrt{thermal resistance}. The ripple current capability of the disclosed motor drive is advantageously higher than a conventional system because of the low ESR and low resistance thermal path to the cooling channel.

With reference to FIG. 8, the integrated motor drive 190 includes a circuit board 206 (e.g., a control board) positioned radially outward from the distributed DC link assembly 10. A ground plate 210 is positioned between the circuit board 206 and the distributed DC link assembly 10. In the illustrated embodiment, the ground plate 210 is electrically coupled to a chassis ground (e.g., the inner housing 46). In other words, the ground plate 210 is a low impedance connection for the circuit board 206 to the grounded inner housing 46. In some embodiments, the circuit board 206 interfaces with the ground plate 210 through an EMI gasket.

Various features and advantages are set forth in the following claims.

1. The integrated motor drive of claim 9, wherein the distributed DC link assembly further comprises:
a first busbar assembly positioned around an axis;
a second busbar assembly positioned around the axis;
wherein the first busbar assembly extends 360 degrees around the axis;
wherein the second busbar assembly extends 360 degrees around the axis.

2. (canceled)

3. The integrated motor drive of claim 1, further including a plurality of electromagnetic interference filter electrically coupled to the first busbar assembly, the second busbar assembly, and a ground.

4. The integrated motor drive of claim 1, wherein the first busbar assembly is at first voltage and the second busbar assembly is at a second voltage lower than the first voltage.

5. The integrated motor drive of claim 9, wherein the distributed DC link assembly further comprises:
a first busbar sector;
a second busbar sector electrically coupled to the first busbar sector;
a third busbar sector electrically coupled to the first busbar sector and the second busbar sector; wherein a first end of the third busbar sector is mechanically coupled to the first busbar sector and a second end of the third busbar sector is mechanically coupled to the second busbar sector;
wherein the first busbar sector, the second busbar sector, and the third busbar sector are positioned an equal distance from a central axis.

6. The integrated motor drive of claim 5, wherein the second busbar sector is identical to the first busbar sector; and wherein the third busbar sector is identical to the first busbar sector; and wherein the first busbar sector, the second busbar sector, and the third busbar sector form a closed loop around the central axis.

7. (canceled)

8. (canceled)

9. An integrated motor drive comprising:
a housing with a cooling channel positioned therein;
a stator positioned within the housing;
a distributed DC link assembly positioned 360 degrees around the housing;
wherein the distributed DC link assembly includes a plurality of capacitor assemblies and a plurality of power modules;
wherein the plurality of capacitor assemblies and the plurality of power modules are coupled the housing and configured to be cooled by the cooling channel.

10. The integrated motor drive of claim 9, further including a thermal layer positioned between each of the plurality of capacitor assemblies and the housing and positioned between each of the plurality of power modules and the housing.

11. The integrated motor drive of claim 9, wherein the distributed DC link assembly includes an electromagnetic interference filter with a Y-capacitor, and a ground bridge coupling the electromagnetic interference filter to a ground.

12. The integrated motor drive of claim 9, further including a circuit board positioned radially outward from the distributed DC link assembly, and a ground plate positioned between the circuit board and the distributed DC link assembly, wherein the circuit board interfaces with the ground plate through an EMI gasket.

13. The integrated motor drive of claim 12, wherein the ground plate is electrically coupled to a ground.

14. The integrated motor drive of claim 9, wherein the distributed DC link assembly further comprises:
a first busbar with a first portion and a second portion extending from the first portion at an angle;
a second busbar with a third portion and a fourth portion extending from the third portion at the angle;
wherein a capacitor assembly of the plurality of capacitor assemblies is electrically coupled to the first busbar and the second busbar, wherein the capacitor assembly is mounted to the first portion of the first busbar and the third portion of the second busbar; and
an electromagnetic interference filter with a capacitor electrically coupled to the first busbar, the second busbar, and a ground, and wherein the electromagnetic interference filter is mounted to the second portion of the first busbar and the fourth portion of the second busbar.

15. The integrated motor drive of claim 14, wherein the first portion is parallel to the third portion and the second portion is parallel to the fourth portion; and wherein the first busbar includes a first interconnect portion extending from the first portion at the angle; and wherein the first busbar includes a second interconnect portion extending from the second portion at the angle; and wherein the second busbar includes a third interconnect portion extending from the third portion at the angle; and the second busbar includes a fourth interconnect portion extending from the fourth portion at the angle; and wherein the third interconnect portion is parallel to the first interconnect portion, and wherein the fourth interconnect portion is parallel to the second interconnect portion.

16. (canceled)

17. (canceled)

18. (canceled)

19. (canceled)

20. The integrated motor drive of claim 15, wherein the first interconnect portion includes a first plurality of slots and the second interconnect portion includes a first plurality of connectors; and wherein the third interconnect portion includes a second plurality of slots and the fourth interconnect portion includes a second plurality of connectors; and
wherein the first plurality of slots includes insulated slots and exposed slots positioned alternatingly along an interconnect axis; and wherein the second plurality of slots includes insulated slots and exposed slots; and wherein the insulated slots of the second plurality of slots are aligned with the exposed slots of the first plurality of slots; and wherein the exposed slots of the second plurality of slots are aligned with the insulated slots of the first plurality of slots; and
wherein the first plurality of connectors and second plurality of connectors are positioned alternatingly along an interconnect axis.

21. (canceled)

22. (canceled)

23. The integrated motor drive of claim 14, wherein the angle is 60 degrees.

24. The integrated motor drive of claim 14, wherein a power module of the plurality of power modules comprises two switching elements; wherein the power module is electrically coupled to the first busbar and the second busbar, wherein the power module is mounted to the second portion of the first busbar and the fourth portion of the second busbar; and
wherein the capacitor of the electromagnetic interference filter is a Y capacitor coupled to a circuit board; and wherein the electromagnetic interference filter further includes a ground bridge that extends between a power module and the circuit board; and
wherein the first busbar includes an aperture formed in the second portion, and wherein an electrical connection to the power module extends through the aperture.

25. (canceled)

26. (canceled)

27. The integrated motor drive of claim 14, wherein the first busbar and the second busbar extend through the capacitor assembly such that the capacitor assembly is at least partially positioned radially inward and radially outward of the first busbar and the second busbar.

28. The integrated motor drive of claim 14, wherein the capacitor assembly includes an equivalent series resistance of less than 1 mΩ; and wherein the capacitor assembly, the first busbar, and the second busbar have a total equivalent series inductance of less than 10 nH.

29. (canceled)

30. The integrated motor drive of claim 14, wherein the first busbar includes a first terminal extending from the first portion, and the second busbar includes a second terminal extending from the third portion; wherein the first terminal is spaced from and parallel to the second terminal.

31. The integrated motor drive of claim 14, wherein the first portion and the second portion are planar.

32. The integrated motor drive of claim 14, wherein the first busbar includes an aluminum core and an electrically insulating coating.
